(19) United States
(12) Patent Application Publication
(10) Pub. No.: US 2011/0288881 A1
(43) Pub. Date: Nov. 24, 2011

(54) Method and System for Processing Healthcare Payments

(75) Inventors: Salah MACHANI, Thornhill (CA); John M. COUSE, Toronto (CA); David Paul KARCHER, Elm Grove, WI (US)

(73) Assignee: DIVERSINET CORP., Toronto (CA)

(21) Appl. No.: 13/113,278

(22) Filed: May 23, 2011

Related U.S. Application Data
(60) Provisional application No. 61/346,982, filed on May 21, 2010.

(51) Int. Cl. G06Q 50/00; G06Q 10/00

(52) U.S. Cl. 705/2

(57) ABSTRACT

A system and method for processing healthcare payments is provided. A payment request is received for a charge for healthcare services provided by a healthcare provider via a communications interface of a computer system. The payment request identifies an end-user receiving the healthcare services. A first payment is received from at least one healthcare insurance plan covering at least a portion of the charge for the end-user. A second payment is received from at least one funding account of the end-user from which the remainder of the charge is to be paid. A third payment is transferred to a financial account associated with the healthcare provider for the charge.

This application claims priority from U.S. Provisional Patent Application Ser. No. 61/346,982, filed on May 21, 2010, the entire contents of which are incorporated herein by reference.

### FIELD OF THE INVENTION

The present invention relates generally to payment systems. More particularly, the present invention relates to a method and system for processing healthcare payments.

### BACKGROUND OF THE INVENTION

The healthcare claims and payment-processing systems in the United States are inefficient. Studies claim that between 10% and 40% of all healthcare spending is spent on non-medical paperwork related to claims, payment and settlement. The environment is challenging as there are hundreds of payers (healthcare insurance companies) distributing monies to hundreds of thousands of providers (healthcare service providers and provider networks). Each payer has their own payment schedule for services provided while each patient may be covered under a different plan depending on whether they are independently covered or part of a group plan. At any one time a provider may be dealing with over 40 different payers. All of the corresponding paperwork has to be submitted, usually through an intermediate aggregator, to be reconciled, adjudicated, and settled.

There are several other factors that significantly impact healthcare claim and payment processing. With advent of high-deductible plans, the patient may be liable for thousands of dollars up-front versus a 10% co-pay or a $20 deductible. Health Savings Accounts (“HAS”) are growing in popularity and patients generally cannot access these funds in real time. The Health Insurance Portability and Accountability Act (“HIPAA”) calls for more transparency for individuals to access their records, but at the same time healthcare identity fraud is growing. Further, studies show that the level of bad debt for healthcare providers who do not collect at the point of service for the patient's obligation increases to over 50%. Inefficiencies in the healthcare marketplace cause payers and providers to cover these escalating costs by either raising rates/fees or decreasing services provided.

Consumers are already conditioned to having access to multiple payment methods when shopping online but may not have enough resources in any one of these funding sources to cover the entire obligation at the point of healthcare service, or may not be able to make a direct payment from one or more of these funding sources.

It is an object of this invention to provide a novel method and system for processing healthcare payments.

### SUMMARY OF THE INVENTION

According to an aspect of the invention, there is provided a method for processing healthcare payments, comprising:

receiving a payment request for a charge for healthcare services provided by a healthcare provider via a communications interface of a computer system, said payment request identifying an end-user receiving said healthcare services;

receiving a first payment from at least one healthcare insurance plan covering at least a portion of said charge for said end-user;

receiving a second payment from at least one funding account of said end-user from which the remainder of said charge is to be paid; and

transferring a third payment to a financial account associated with said healthcare provider for said charge.

The method can further include:

storing an electronic address for said end-user; and

sending said invoice payment request via said electronic address.

The method can further include:

storing an electronic address for said end-user; and

sending an electronic message providing notification of said invoice payment request via said electronic address.

The sending can include including a link to the invoice payment request in the electronic message. The invoice payment request can be formatted for viewing on a mobile device.

The sending can include sending an electronic message to the electronic address, the electronic message including the invoice payment request for viewing via a healthcare application on a mobile device.

The method can further include:

storing funding account information for at least one funding account of said end-user; and

enabling said end-user to select at least one of said funding accounts for payment of said charge;

and wherein receiving said second payment comprises:

withdrawing funds from said at least one selected funding accounts.

The storing funding account information can further include storing an account identifier for each of the at least one funding account, and transmitting the account identifier to the end-user for facilitating selection of the at least one of the funding accounts.

The method can further include:

storing plan information for at least one healthcare insurance plan under which said end-user may receive benefits; and

enabling said end-user to select at least one of said healthcare insurance plans for claiming benefits under for said charge.

The storing plan account information can further include storing a plan identifier for each of the at least one healthcare insurance plan, and transmitting the plan identifier to the end-user for facilitating selecting of the at least one of the healthcare insurance plans.

The method can further include:

estimating benefits payable under said at least one healthcare insurance plan for said charge;

estimating the remainder of said charge payable by said end-user; and

including said estimated benefits payable and said estimated remainder in said invoice payment request.

The invoice payment request can enable the end-user to select which of the at least one funding account to make the second payment from.

The method can further include debiting an end-user float account if the balance is not covered by the end-user.

The payment request can be received from a healthcare provider system associated with the healthcare provider.

The method can further include adjusting an end-user float account for a difference between the estimated benefits payable under the at least one healthcare insurance plan and adjudicated benefits payable under the at least one healthcare insurance plan.

The transferring can occur after the receiving of the second payment.

According to another aspect of the invention, there is provided a computer system for processing healthcare payments, comprising:

storage for storing plan information for at least one healthcare insurance plan under which an end-user is insured;

a communications interface for receiving a payment request for a charge for healthcare services provided by a healthcare provider, said payment request identifying an end-user receiving said healthcare services; and

a healthcare payment-processing program, in response to said communications interface receiving said payment request, determining estimated benefits payable on behalf of said end-user under said at least one healthcare insurance plan for said charge, estimating an end-user-payable amount, generating an invoice payment request indicating said estimated end-user-payable amount, and transmitting said invoice payment request to said end-user.

The storage can store an electronic address of the end-user, and the healthcare payment-processing program can transmit a notification to the electronic address when the invoice payment request is generated.

The storage can store an electronic address of the end-user, and the healthcare payment-processing program can transmit the invoice payment request to the electronic address.

The invoice payment request can be formatted for viewing on a mobile device.

The storage can store funding account information for at least one funding account of the end-user, and the invoice payment request generated by the healthcare payment-processing program can enable selection of at least one of the funding accounts for payment of the estimated end-user-payable amount.

The storage can store an account identifier for each of the at least one funding account, and the invoice payment request can enable selection of the at least one of the funding accounts using the account identifiers.

The storage can store a plan identifier for each of the at least one healthcare insurance plans, and the invoice payment request can enable selection of the at least one of the healthcare insurance plans using the plan identifiers.

The storage can store a notional end-user float account balance and can debit or credit the notional end-user float account balance for a difference between the estimated end-user-payable amount and an actual end-user-payable amount.

The healthcare payment-processing program, in response to the communications interface receiving an estimate request for a proposed healthcare service, the estimate request including an estimated charge for the proposed healthcare service, estimates benefits payable on behalf of the end-user under the at least one healthcare insurance plan for the proposed healthcare service, can estimate an end-user-payable amount, generate an estimated invoice indicating the estimated end-user-payable amount, and transmit the invoice payment request to the end-user.

### BRIEF DESCRIPTION OF THE DRAWINGS

Embodiments will now be described, by way of example only, with reference to the attached Figures, wherein:

FIG. 1 shows a system for processing healthcare payments and its operating environment in accordance with an embodiment of the invention;

FIG. 2 shows a number of components of the healthcare payment-processing system of FIG. 1;

FIG. 3 shows a number of components of the mobile device of FIG. 1;

FIG. 4 shows the general method of registering an end-user with the healthcare payment-processing system of FIG. 1;

FIG. 5 shows the general method of processing healthcare payments via the healthcare payment-processing system of FIG. 1;

FIG. 6 shows the general communications transmitted and received between the healthcare payment-processing system and various other systems and devices of FIG. 1; and

FIG. 7 shows a payment confirmation screen presented by the mobile device of FIG. 3.

### DETAILED DESCRIPTION OF THE EMBODIMENTS

The invention provides a system and method for processing healthcare payments. A healthcare payment-processing system receives a payment request for a charge for healthcare services via a communications interface. The request identifies an end-user receiving the healthcare services. At least one healthcare insurance plan covering at least a portion of the charge for the end-user is identified. Payment information is received from the end-user identifying at least one funding account from which the remainder of the charge is to be paid. A payment is transferred to a provider financial account for the charge.

Healthcare services include the testing for and treatment of diseases and dysfunctions. This can include the dispensation of prescriptions, medical devices, the collection and analysis of blood and biopsy samples, physiotherapy, psychotherapy, hospital stays, etc.

By having a healthcare payment-processing system manage the payment of the full charge for the healthcare services, the claim and end-user-payable payment process, as well as the administrative paperwork, can be streamlined. The healthcare provider may receive immediate payment for the services rendered.

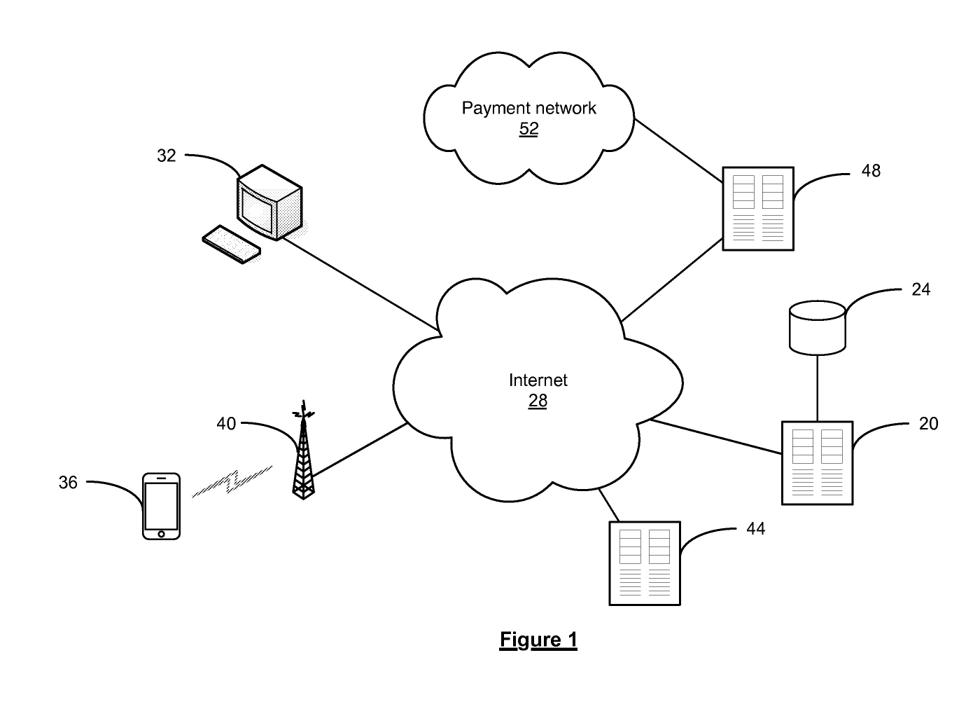

FIG. 1 is a high-level diagram of a healthcare payment-processing system 20 and its operating environment in accordance with an embodiment of the invention. The healthcare payment-processing system 20 has access to a healthcare insurance and funding database 24, and is in communication with a large, public communications network such as the Internet 28. A healthcare provider system 32 is in communication with the healthcare payment-processing system 20 over the Internet 28. The healthcare provider system 32 is operated on behalf of a provider of healthcare services, such as a doctor, a therapist, a lab, etc. For example, the healthcare provider system 32 may reside physically in the office of a doctor. A mobile device 36 communicates via cellular communications with the cellular communications tower 40 that, in turn, is in communication with the Internet 28 via a number of intermediate servers operated by one or more cellular communications carriers (not shown). The mobile device 36 is operated by an end-user of the healthcare payment-processing system 20; that is, a recipient of healthcare services.

The healthcare payment-processing system 20 is also in communication with a set of healthcare insurance company systems 44 (although, for ease of illustration, only one is shown). The healthcare insurance company systems 44 store healthcare insurance plan details for insured end-users. The insurance plan details can include the name of the plan member, the names of all end-users and other people covered under the plan, the type of coverage provided for the insured end-users, any maximum amounts payable for a particular healthcare service, deductibles, co-pays, any healthcare account balances if coverage is capped, details about the benefits, etc.

Additionally, the healthcare payment-processing system 20 is in communication with a payment gateway 48, which is, in turn, in communication with a payment network 52. The payment gateway 48 can be a server operated by a bank that initiates the transfer of funds from one account to another. The payment network 52 effects the transfer.

The healthcare insurance and funding database 24 stores login credentials, as well as an electronic address, for a plurality of end-users. The login credentials include a login name and password combination. The electronic address can be an email address, a telephone number for receiving Short Message Service (“SMS”, or text) messages, a messaging account address, etc. In addition, the healthcare insurance and funding database 24 stores healthcare insurance plan information and funding account information for each end-user. The healthcare insurance plan information includes an identifier of the healthcare insurance company, an identifier for the healthcare insurance plan and an identifier for the plan member as assigned by the healthcare insurance company.

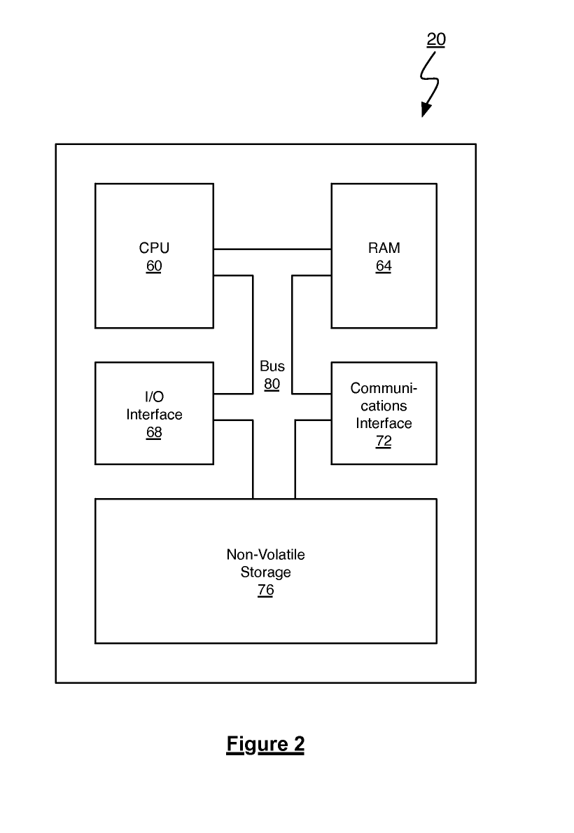

FIG. 2 shows a number of physical and logical components of the healthcare payment-processing system 20, including a central processing unit (“CPU”) 60, random access memory (“RAM”) 64, an input/output (“I/O”) interface 68, a communications interface 72, non-volatile storage 76, and a local bus 80 enabling the CPU 60 to communicate with the other components. The CPU 60 executes an operating system and a healthcare payment-processing program that provides the desired functionality. RAM 64 provides relatively responsive volatile storage to the CPU 60. The I/O interface 68 allows for input to be received from one or more devices, such as a keyboard, a mouse, etc., and outputs information such as to a display and/or speakers. The communications interface 72 permits communication with other systems, such as the mobile device 36, the healthcare provider system 32, the healthcare insurance company systems 44 and the payment gateway 48 via the Internet 28. Non-volatile storage 76 stores the operating system and healthcare payment-processing program. In addition, the non-volatile storage 76 stores the healthcare insurance and funding database 24.

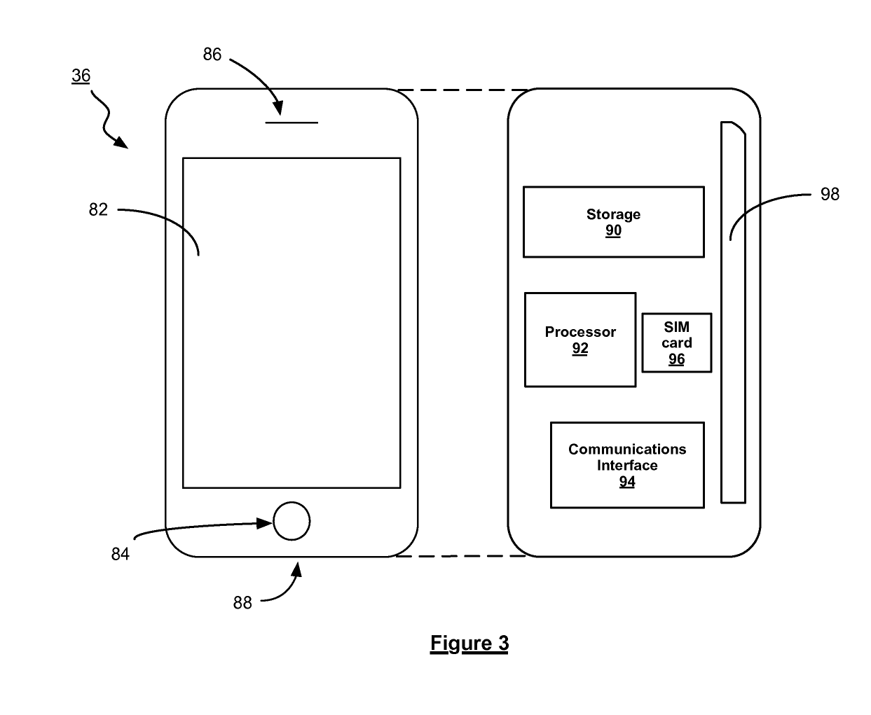

Referring to FIG. 3, a number of components of the mobile device 36 are shown. As illustrated, in this embodiment, the mobile device 36 is a smartphone that executes a mobile operating system such as Apple™ iOS™ or Google™ Android™. The mobile device 36 has a touch screen 82, one or more hardware buttons 84, one or more speakers 86 and a microphone 88. The touchscreen 82 presents information graphically, and enables an end-user to scroll through a document, screen or page, and activate soft keys, hyperlinks, etc. The hardware buttons 84 enable interaction with the operating system of the mobile device 36. The speakers 86 play audio notifications and other audio output, including voice output, to the end-user. The microphone 88 captures audio from the end-user for transmission during a phone call, for activating operating system and application features using voice command functionality, etc. The mobile device 36 also includes storage 90 for storing the operating system that controls the main functionality of the mobile device 36, along with a number of applications that are run on the mobile device 36, and data. A processor 92 executes the operating system and applications. A SIM card 94 provides additional storage for storing applications and data, and has a microprocessor for executing them. Additionally, the SIM card 94 has a unique hardware identification code that permits identification of the mobile device 36 on a cellular communications network. When installed, the SIM card 94 forms part of the mobile device 36. Other types of mobile devices can have encrypted device storage in place of the SIM card 94 that offers the equivalent functionality. A communications interface 96 permits communications with a cellular network for voice and data via an internal antenna 98. The communications interface 96 also enables communications via other wireless and wired channels, such as Bluetooth and universal serial bus (“USB”).

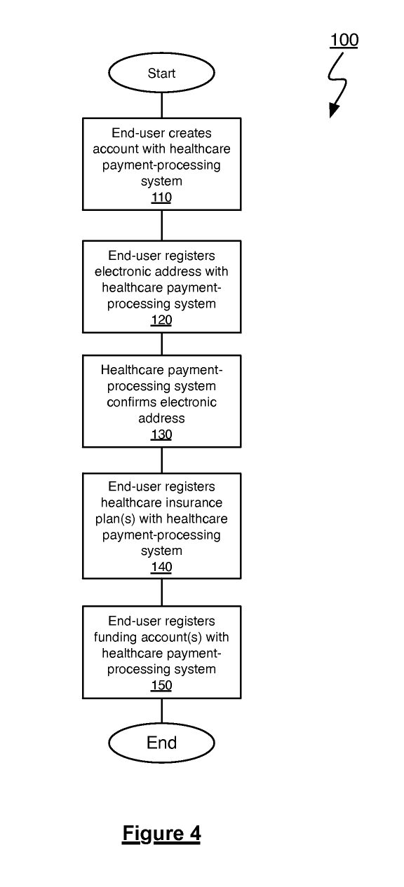

FIG. 4 shows the general method of registering an end-user with the healthcare payment-processing system 20 at 100. End-user registration is performed through a Web interface generated by the healthcare payment-processing system 20. The end-user can register or modify his account via a Web browser operating on a personal computer, on the mobile device 36, etc. The method 100 commences with the end-user creating an account with the healthcare payment-processing system 20 (110). During account creation, the end-user enters a desired login name and password, as well as other vital information. Once an account is created for the end-user at 110, the end-user registers an electronic address with the healthcare payment-processing system 20 (120). The end-user selects an electronic address to which he would like the healthcare payment-processing system 20 to forward payment-processing messages to. The electronic address can be an electronic mail (“email”) address, a telephone number associated with the mobile device 36 for text messages, a messaging account, etc. to which messages can be sent and can be received by the mobile device 36.

Upon receipt of the electronic address for the end-user, the healthcare payment-processing system 20 confirms the electronic address provided (130). In particular, the healthcare payment-processing system 20 generates a confirmation message and sends it to the electronic address provided. The confirmation message includes a hyperlink and a unique end-user identifier for the end-user. The unique end-user identifier can be provided to healthcare providers to uniquely identify the end-user to the healthcare payment-processing system 20. Upon end-user activation of the hyperlink, a Web browser application is launched on the mobile device 36 and requests a Web page from the healthcare payment-processing system 20 identified by the hyperlink. The Web page identified by the hyperlink is addressed such that its request confirms the electronic address to which the confirmation message was sent. In response, the healthcare payment-processing system 20 generates and serves a Web page that indicates that the electronic address is confirmed, and includes a link to allow the end-user to continue with the registration of the end-user with the healthcare payment-processing system 20. Alternatively, if the end-user commenced the registration process on a computer, the end-user may choose to continue the registration process via the computer.

Once the electronic address provided by the end-user is confirmed, the end-user registers one or more healthcare insurance plans under which the end-user is entitled to benefits with the healthcare payment-processing system 20 (140). In particular, the healthcare payment-processing system 20 presents a screen that enables the end-user to input information regarding healthcare insurance plans under which the end-user is entitled to benefits. For each healthcare insurance plan that the end-user registers, the end-user selects the name of the healthcare insurance company from a drop-down list or enters in free text until a healthcare insurance company matching the free text is displayed. Additionally, the end-user enters in an identifier identifying the plan under which he or she is covered, and an identifier for the plan member as assigned by the healthcare insurance company. The plan member may differ from the end-user where plan coverage extends to spouses, partners, family members, children, pets, etc. Further, the end-user may enter in a user-friendly plan identifier for each healthcare insurance plan that will be used to identify the healthcare insurance plan later to the end-user. Upon entry of each healthcare insurance plan under which the end-user is entitled to benefits, the healthcare payment-processing system 20 confirms the information and eligibility with the appropriate healthcare insurance company system 44 where the healthcare insurance companies mandate such prioritization.

The healthcare insurance plans for an end-user can be prioritized such that benefits under a first healthcare insurance plan are applied before benefits under a second healthcare insurance plan are applied, etc. This information may be retrieved by the healthcare payment-processing system 20 from the healthcare insurance company systems 44.

Upon indicating that there are no further healthcare insurance plans to register, the end-user registers one or more funding accounts with the healthcare payment-processing system 20 (150). In particular, the healthcare payment-processing system 20 presents a screen that enables the end-user to input information for funding accounts from which funds can be drawn to pay for end-user-payable amounts for healthcare services. End-user-payable amounts include deductibles, co-pays and amounts in excess of the maximum benefits payable under healthcare insurance plans. Funding accounts can include bank accounts, lines of credit, credit card accounts and other credit instruments, Flexible Spending Accounts (“FSAs”), Health Savings Accounts (“HSAs”), Health Reimbursement Arrangements (“HRAs”), etc. For each funding account that the end-user registers, the end-user selects the name of the financial institution (such as “Citibank”) or issuing party (such as “VISA”) from a drop-down list or enters in free text until a financial institution or issuing party matching the free text is displayed. In addition, the end-user enters the branch (if applicable), the account number, the name on the account, and the expiration date (for credit card accounts). Further, the end-user may enter in a user-friendly account identifier for each funding account that will be used to identify the funding account later to the end-user. Upon entry of each funding account from which funds can be drawn to pay for end-user-payable amounts for healthcare services, the healthcare payment-processing system 20 confirms the information with the appropriate financial institutions and issuing parties via the payment gateway 48.

Upon entry of the funding account information by the end-user, the registration is complete and the method 100 ends.

Once an end-user is registered with the healthcare payment-processing system 20, a notional float account is established for the end-user. The float account is used to capture differences between the estimated and actual end-user-payable amounts, as will be described below.

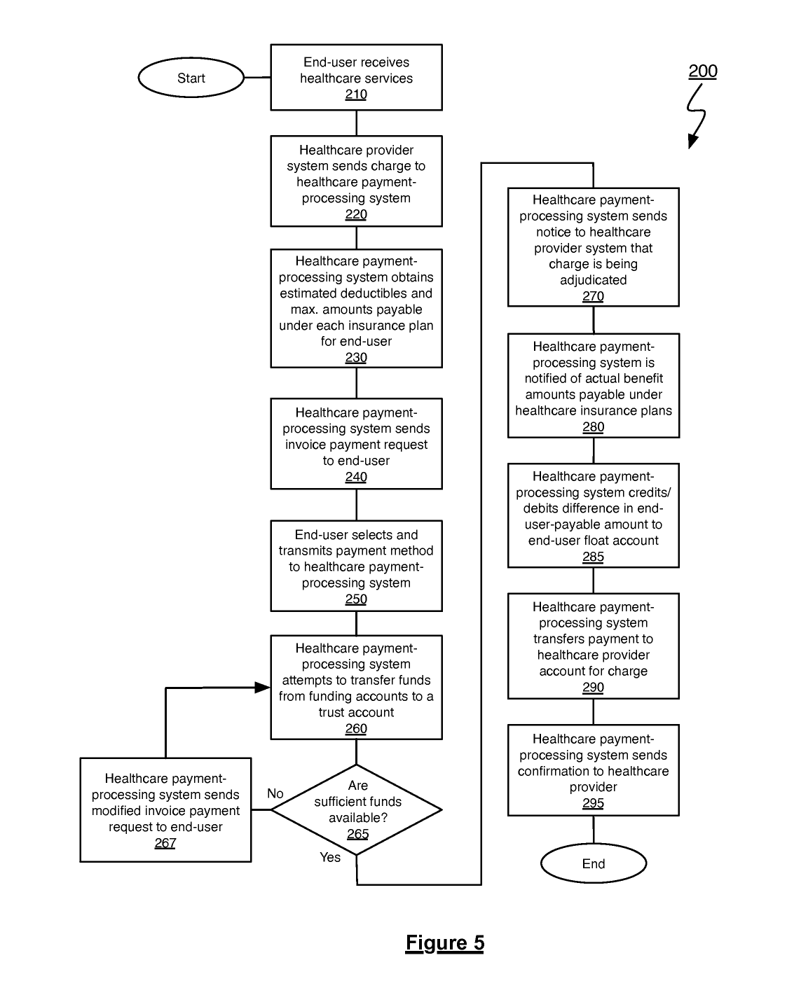

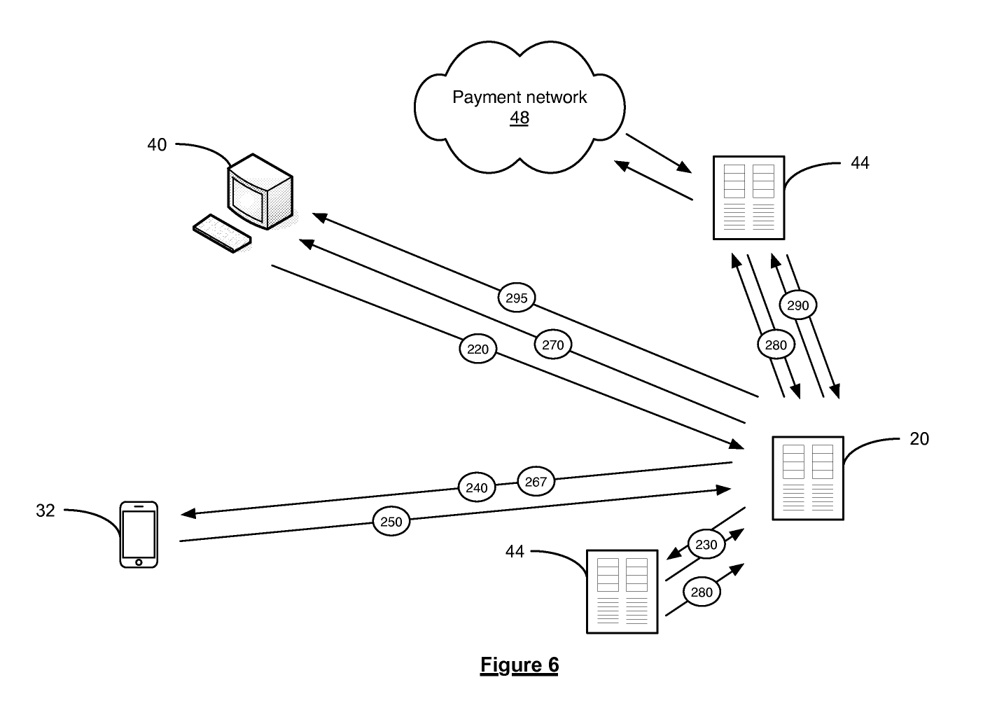

Operation of the healthcare payment-processing system 20 will now be described with reference to FIGS. 5 and 6. In particular, FIG. 5 shows the general method 200 of processing healthcare payments using the healthcare payment-processing system 20. FIG. 6 shows the general communications between the healthcare payment-processing system 20 and other systems and devices carried out during the method 200.

The method 200 commences with the end-user receiving healthcare services (210). The end-user makes a visit to a doctor, physiotherapist, lab, etc. Healthcare services are charged based on the type of diagnostic or treatment service provided. After the healthcare services have been provided, the healthcare provider enters in the healthcare services rendered by selecting a patient and selecting the appropriate diagnosis and treatment codes corresponding to the healthcare services rendered. When a patient first visits a healthcare provider, a record is created on the healthcare provider system 32. The record is associated with the end-user's account on the healthcare payment-processing system 20. This can be done via entry of the end-user's name, street address, etc. In addition or alternatively, the unique end-user identifier generated by the healthcare payment-processing system 20 can be entered.

In some cases, a diagnostic or treatment code may be multiply entered. For example, in the provision of dental services, different patients may require varying amounts of dental cleaning. As a result, units are defined that represent cleaning for a set number of minutes, such as fifteen minutes, and a patient may be provided with two units of dental cleaning.

The healthcare provider system 32 has a fee schedule corresponding to the diagnostic and treatment codes. It then generates charges itemized for each diagnostic and treatment code for the healthcare services rendered.

Once the charges are generated, the healthcare provider system 32 sends a payment request for the charges to the healthcare payment-processing system 20 (220). The payment request includes the unique end-user identifier, the diagnostic and treatment codes and the corresponding charges, and a timestamp to indicate when the services were rendered. The healthcare provider system 32 is known to the healthcare payment-processing system 20 and credentials for authenticating the healthcare provider system 32 to the healthcare payment-processing system 20 are pre-provided to the healthcare payment-processing system 20. The healthcare provider system 32 encrypts and signs the communication with the charges. In this manner, the healthcare payment-processing system 20 can authenticate the healthcare provider system 32, ensure that the data received has not been tampered with or otherwise corrupted, and store the communication to protect against non-repudiation.

Upon receiving the payment request from the healthcare provider system 32, the healthcare payment-processing system 20 determines estimated deductibles, co-pays and maximum amounts payable under each insurance plan for the end-user for the charges (230). Upon receiving the payment request, the healthcare payment-processing system 20 authenticates the payment request and verifies the payment request's integrity. It then decrypts the communication and parses the end-user's unique identifier, the timestamp, the list of diagnostic and treatment codes, and the detailed charge breakdown. The healthcare payment-processing system 20 then retrieves the end-user's healthcare insurance plan information and funding account information from the healthcare insurance and funding database 24 using the unique end-user identifier.

The healthcare payment-processing system 20 then determines what estimated benefit amounts are payable, if any, under each insurance plan. If the healthcare insurance and funding database 24 stores plan priority information, the healthcare payment-processing system 20 obtains the estimated benefit amounts for the diagnostic and treatment codes under the healthcare insurance plans in the specified order in order to determine offsets. If the order is not specified, the benefits payable under each healthcare insurance plan are determined.

Upon determining the estimated benefits payable under the healthcare insurance plans, the healthcare payment-processing system 20 sends an invoice payment request to the end-user (240). In preparation for sending the invoice payment request, the healthcare payment-processing system 20 retrieves the funding account information of the end-user to determine what payment sources are available for payment of any amounts payable by the end-user. The payment sources (i.e., the funding accounts) may be prioritized by the end-user, so that payment is always made from a particular funding account when funds are available. Alternatively, where an end-user has not specified a priority for the funding accounts, the funding accounts may be prioritized based on where funds were last drawn from to pay healthcare expenses.

Where the healthcare insurance plans and funding accounts are prioritized, the healthcare payment-processing system 20 can prepare a payment request on the basis that a claim is made against a prioritized healthcare insurance plan and that the end-user-payable amount is drawn from a prioritized funding account. In such cases, the end-user can be presented with the above-specified configuration as a default option with an alternative option to revise the selection of healthcare insurance plans against which a claim is to be made, if permissible, and/or funding accounts from which funds are to be drawn.

As the benefits payable under the selected healthcare insurance plans may be estimated, the amount payable by the end-user may also be estimated.

The invoice payment request is accessed as a hyperlink in a message sent to the electronic address specified by the end-user. The hyperlink, when activated, directs the mobile device 36 of the end-user to a Web page generated by the healthcare payment-processing system 20 after the end-user has entered in their login credentials. The Web page is formatted for the screen of the mobile device 36 and presents the invoice payment request.

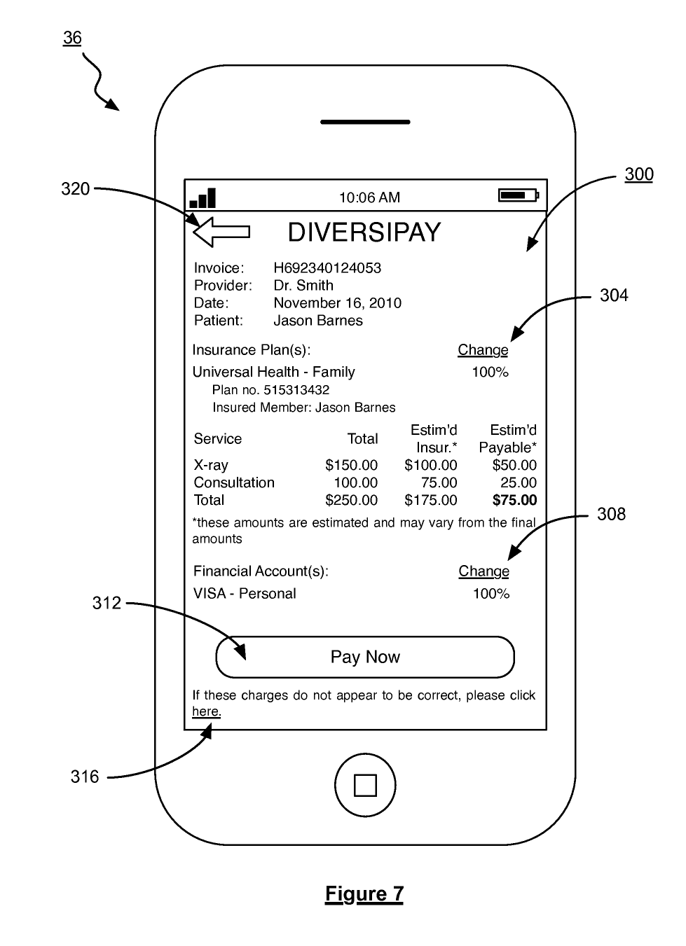

FIG. 7 shows an exemplary Web page 300 that represents the invoice payment request an end-user is presented with on the mobile device 36 upon activating the hyperlink. The Web page 300 presents an invoice number the name of the healthcare provider, the date that the healthcare services were rendered, and the name of the end-user. The healthcare insurance plans selected against which a claim is to be remitted are also shown. A link 304 enables the end-user to revise what healthcare insurance plan(s) to make a claim against for the current charge. Further, if permitted, the end-user can specify more than one insurance plan and apportion the claim to the various insurance plans. Where the coverage under more than one insurance plan can stack, the end-user can select the insurance plans and specify 100% for each. In this case, the healthcare payment-processing system 20 will estimate the benefit amounts payable under each plan. The end-user can also add information for additional healthcare insurance plans at that time.

The charges for the services performed are shown. In addition to the charges for each service, the Web page 300 presents the estimated insured portions of the charges under the selected healthcare insurance plans, and the estimated net amounts payable by the end-user. Totals are provided for the charges, the estimated insured amounts and the estimated payable amounts. The funding accounts from which funds are to be drawn to cover the end-user payable amount are shown. A link 308 enables the end-user to revise what funding accounts to draw funds from to cover the payment.

An end-user can authorize the claims against the selected healthcare insurance plans and approve the payment from the selected funding accounts to cover the estimated end-user-payable amount by activating a “pay now” button 312. Finally, the Web page 300 also presents a link 316 that the end-user can activate if the charges appear to be incorrect. A “back arrow” 320 takes an end-user back to a screen presenting a list of past and present invoices the end-user has been sent.

Returning again to FIG. 7, once the end-user is satisfied with the method of payment for the healthcare services rendered and activates the “pay now” button 312, the mobile device 36 transmits the payment method to the healthcare payment-processing system 20 (250). The transmission of the payment method to the healthcare payment-processing system 20 is accepted as approval of the charges and payment method.

Upon receipt of the selected payment method from the end-user, the healthcare payment-processing system 20 then attempts to transfer funds to cover the estimated balance payable by the end-user from the funding accounts specified by the end-user to a trust account established for the healthcare payment-processing system 20 (260).

The healthcare payment-processing system 20 either receives notification that the transfer is complete or that insufficient funds are available (265). If sufficient funds are not available in the funding accounts specified by the end-user, the healthcare payment-processing system 20 sends a modified invoice payment request to the end-user (267). The modified invoice payment request indicates to the end-user that there were insufficient funds in the previously-selected funding accounts. In addition, the regenerated invoice payment request can include a new button enabling the end-user to use the float account to cover the end-user payable amount.

Once the end-user-payable amount has been received or the float account has been debited, the healthcare payment-processing system 20 sends a notice to the healthcare provider system 32 that the charges are being adjudicated (270).

Once the actual benefit amounts payable for the charges under the healthcare insurance plans have been adjudicated, the healthcare insurance company systems 44 notify the healthcare payment-processing system 20 of these amounts (280). If there are discrepancies between the estimated and actual benefit amounts payable under the healthcare insurance plans, the end-user float account is debited or credited with the difference (285). By adjusting the end-user float account for any discrepancies between the estimated and actual benefits payable under the healthcare insurance plans for an end-user, the estimated end-user-payable amount can be drawn immediately from the end-user's funding accounts without having to wait for these amounts to be adjudicated. The end-user may be presented with any such differences for payment or for crediting at a later time, such as during the next time the end-user is presented with an invoice payment request or at some frequency, such as once a month. Alternatively, a funding account specified by the end-user can be credited or debited at a later time with the end-user's prior approval.

Upon being notified of the adjudicated amounts, from the healthcare insurance companies, the healthcare payment-processing system 20 transfers payment to a healthcare provider account for the charges (290). In particular, the healthcare payment-processing system 20 sends instructions for the payment to the payment gateway 48, which in turn processes the payment via the payment network 52. This can take up to 72 hours in some cases. Upon instructing the payment gateway 48 to transfer the payment, the healthcare payment-processing system 20 sends confirmation that the payment to the healthcare provider system 32 has been initiated to the healthcare provider system 32 (295).

Upon transmission of the confirmation of payment to the healthcare provider system 32, the method 200 of processing healthcare payments ends.

The healthcare payment-processing system 20 can generate and server other Web pages to the mobile device 36 of the end-user, such as for adding, editing or removing funding accounts and healthcare insurance plans, for viewing account balances in the funding accounts, for viewing healthcare account balances for insurance plans that provider for one, etc.

The healthcare payment-processing system 20 can also provide estimates for procedures. Upon request from an end-user, a healthcare provider can cause the healthcare provider system 32 to send an estimate request to the healthcare payment-processing system 20. The healthcare payment-processing system 20 performs all of the same functions as when providing an end-user with an invoice payment request, except that an estimate message is generated instead. The estimate message, much like the invoice payment request, takes the form of a Web page to which the mobile device 36 is directed. The Web page for presenting the estimate is very similar to that shown in FIG. 7, except that it is clearly noted that all amounts are estimates and do not relate to an actual charge. The end-user can, by selecting healthcare insurance plans and funding accounts, (a) determine if he has enough insurance coverage and personal funds combined to cover the total estimated charges; (b) view the remaining balance in each of the selected funding accounts; (c) view the remaining balance for any healthcare insurance plans where a balance is maintained (such as where claims are capped at a specified dollar amount per annum); and (d) approve the estimate.

The healthcare provider may separately initiate a patient check on the end-user to verify that the end-user has coverage and how much the end-user has. The healthcare payment-processing system 20 can reply with this information, together with a risk rating for non-payment by the end-user for the end-user-payable portion.

A discount between the healthcare provider and the operator of the healthcare payment-processing system 20 may be negotiated to compensate for the facilitation of recovering payments for healthcare services. This discount may be kept by the operator of the healthcare payment-processing system 20, with the gross charges being presented to the healthcare insurance companies and the end-users.

The healthcare payment-processing system 20 also enables end-users to independently estimate costs for healthcare services. It provides a Web page that is accessible after the user has logged in. The end-user can select healthcare services either by performing text searches for the services in mind or by navigating through one or more ordered lists of healthcare services. These healthcare services correspond to diagnostic and treatment codes. Upon entry of the healthcare services, the end-user can be presented with estimated total costs for the healthcare services and can select one or more healthcare insurance plans to determine what estimated amount(s) may be payable under each plan. Further, the end-user can be presented with the estimated net cost to him or her for each healthcare service. In this manner, an end-user can determine what the estimated impact is of healthcare services to his healthcare insurance plans (this is of use where the end-user has maxima for claims) and what the financial cost is to the end-user directly.

The benefits of the system include the following:
improved customer service as the end-user can be made aware of their eligibility and coverage under their healthcare insurance plans for certain healthcare services in real time, and can make informed decisions regarding how to fund their financial obligations at the point of service;
management of the float of the end-user's financial responsibility to the healthcare provider;
cost reductions for collections and bill resubmission;
improved billing and payment accuracy, detecting claim errors in real time before submission;
improved tracking of healthcare service charges; and
reduction of compliance risk.

Direct benefits of the system to the healthcare provider include:
enabling end-users expanded options for payment methods;
increased service and validation of eligibility at the point of service;
accelerated claim and payment processing, resulting in faster payment of the healthcare providers; and
more transparency to end-users, creating a better experience for them.

In an alternative embodiment, the funding account information may be provided by the end-user via the mobile device 36 each time payment is required for healthcare services. In this manner, the funding account information need not be stored by the healthcare payment-processing system.

In a further embodiment, the healthcare payment-processing system interacts with a healthcare application that can be downloaded and installed on the mobile device of an end-user. The healthcare application can be a “wallet” application, such as disclosed in U.S. patent application Ser. No. 11/953,696, published on Jun. 19, 2008, the contents of which are incorporated herein in their entirety by reference. The healthcare application can generate similar screens as described in the embodiment described above. For example, the healthcare application can enable an end-user to view present and past invoice payment requests, healthcare account balances, the balance and transactions for the float account, edit the funding accounts and healthcare insurance plans, view the end-user's unique end-user identifier, etc. The healthcare application can include the ability to communicate with the institutions administering the funding accounts of the end-user. In this manner, the end-user can remit payments to the healthcare payment-processing system without the need to have the healthcare payment-processing system store information regarding the funding accounts of the end-user. When setting-up the healthcare application on the mobile device, the healthcare application can be provisioned with a token for providing additional authentication to the healthcare application to the healthcare payment-processing system. Another advantage of such a healthcare application is that the unique end-user identifier can be stored therein, facilitating the providing of the unique end-user identifier to a healthcare provider. For example, the unique end-user identifier can be provided to the healthcare provider system by Near Field Communications, Bluetooth, WiFi, the generation of a barcode on the display of the mobile device that can be scanned by a scanner connected to the healthcare provider system, etc. The healthcare application can receive communications such as an invoice payment request from the healthcare payment-processing system directly via push, can check when launched or otherwise activated by the end-user, etc. Other advantages of implementing the invention using an application installed on a mobile device of an end-user include the ability to send push and other messages to the mobile device application for collective presentation to the user, having the application automatically launch when a message is received from the healthcare payment-processing system, having the application remind the end-user about payments such as for the float account, etc. Further, the application can make the data available for viewing when network connectivity is unavailable.

The invoice payment requests can be sent directly to the electronic address provided by the end-user, can be sent as a link to download or otherwise retrieve the invoice payment requests, etc. For example, the invoice payment requests can be sent in its entirety in an email, or a link to retrieve the invoice payment request can be sent in the email. Where a healthcare application is installed on a mobile device, the invoice payment request can be sent directly to the mobile device for handling by the healthcare application.

While the healthcare payment-processing system is described and illustrated in accordance with a preferred embodiment as a single, physical computer system, it will be appreciated by those skilled in the art that the healthcare payment-processing functionality/service provided by the healthcare payment-processing system can be provided by two or more physical computers. Where there is more than one physical computer, the computers can be in communication with one another over a local area network, or can be distributed remotely and in communication with each other via one or more communication networks.

The above-described embodiments are intended to be examples of the present invention and alterations and modifications may be effected thereto, by those of skill in the art, without departing from the scope of the invention which is defined solely by the claims appended hereto.

What is claimed is:

1. A method for processing healthcare payments, comprising:
receiving a payment request for a charge for healthcare services provided by a healthcare provider via a communications interface of a computer system, said payment request identifying an end-user receiving said healthcare services;
receiving a first payment from at least one healthcare insurance plan covering at least a portion of said charge for said end-user;
receiving a second payment from at least one funding account of said end-user from which the remainder of said charge is to be paid; and
transferring a third payment to a financial account associated with said healthcare provider for said charge.

2. The method of claim 1, further comprising:
storing an electronic address for said end-user; and
sending said invoice payment request via said electronic address.

3. The method of claim 1, further comprising:
storing an electronic address for said end-user; and
sending an electronic message providing notification of said invoice payment request via said electronic address.

4. The method of claim 3, wherein said sending comprises:
including a link to said invoice payment request in said electronic message.

5. The method of claim 4, wherein said invoice payment request is formatted for viewing on a mobile device.

6. The method of claim 3, wherein said sending comprises:
sending an electronic message to said electronic address, said electronic message including said invoice payment request for viewing via a healthcare application on a mobile device.

7. The method of claim 3, further comprising:
storing funding account information for at least one funding account of said end-user; and
enabling said end-user to select at least one of said funding accounts for payment of said charge;
and wherein receiving said second payment comprises:
withdrawing funds from said at least one selected funding accounts.

8. The method of claim 7, wherein said storing funding account information further comprises storing an account identifier for each of said at least one funding account, and transmitting said account identifier to said end-user for facilitating selection of said at least one of said funding accounts.

9. The method of claim 3, further comprising:
storing plan information for at least one healthcare insurance plan under which said end-user may receive benefits; and
enabling said end-user to select at least one of said healthcare insurance plans for claiming benefits under for said charge.

10. The method of claim 9, wherein said storing plan account information further comprises storing a plan identifier for each of said at least one healthcare insurance plan, and transmitting said plan identifier to said end-user for facilitating selecting of said at least one of said healthcare insurance plans.

11. The method of claim 6, further comprising:
estimating benefits payable under said at least one healthcare insurance plan for said charge;
estimating the remainder of said charge payable by said end-user; and
including said estimated benefits payable and said estimated remainder in said invoice payment request.

12. The method of claim 5, wherein said invoice payment request enables said end-user to select which of said at least one funding account to make said second payment from.

13. The method of claim 1, further comprising:
debiting an end-user float account if said balance is not covered by said end-user.

14. The method of claim 1, wherein said payment request is received from a healthcare provider system associated with said healthcare provider.

15. The method of claim 11, further comprising:
adjusting an end-user float account for a difference between said estimated benefits payable under said at least one healthcare insurance plan and adjudicated benefits payable under said at least one healthcare insurance plan.

16. The method of claim 1, wherein said transferring occurs after said receiving of said second payment.

17. A computer system for processing healthcare payments, comprising:
storage for storing plan information for at least one healthcare insurance plan under which an end-user is insured;
a communications interface for receiving a payment request for a charge for healthcare services provided by a healthcare provider, said payment request identifying an end-user receiving said healthcare services; and
a healthcare payment-processing program, in response to said communications interface receiving said payment request, determining estimated benefits payable on behalf of said end-user under said at least one healthcare insurance plan for said charge, estimating an end-user-payable amount, generating an invoice payment request indicating said estimated end-user-payable amount, and transmitting said invoice payment request to said end-user.

18. The computer system of claim 17, wherein said storage stores an electronic address of said end-user, and said healthcare payment-processing program transmits a notification to said electronic address when said invoice payment request is generated.

19. The computer system of claim 17, wherein said storage stores an electronic address of said end-user, and said healthcare payment-processing program transmits said invoice payment request to said electronic address.

20. The computer system of claim 17, wherein said invoice payment request is formatted for viewing on a mobile device.

21. The computer system of claim 17, wherein said storage stores funding account information for at least one funding account of said end-user, and said invoice payment request generated by said healthcare payment-processing program enables selection of at least one of said funding accounts for payment of said estimated end-user-payable amount.

22. The computer system of claim 21, wherein said storage stores an account identifier for each of said at least one funding account, and said invoice payment request enables selection of said at least one of said funding accounts using said account identifiers.

23. The computer system of claim 22, wherein said storage stores a plan identifier for each of said at least one healthcare insurance plans, and said invoice payment request enables selection of said at least one of said healthcare insurance plans using said plan identifiers.

24. The computer system of claim 17, wherein said storage stores a notional end-user float account balance and debits or credits said notional end-user float account balance for a difference between said estimated end-user-payable amount and an actual end-user-payable amount.

25. The computer system of claim 17, wherein said healthcare payment-processing program, in response to said communications interface receiving an estimate request for a proposed healthcare service, said estimate request including an estimated charge for said proposed healthcare service, estimates benefits payable on behalf of said end-user under said at least one healthcare insurance plan for said proposed healthcare service, estimates an end-user-payable amount, generates an estimated invoice indicating said estimated end-user-payable amount, and transmits said invoice payment request to said end-user.
